(19) United States
(12) Patent Application Publication
(10) Pub. No.: US 2014/0152133 A1
(43) Pub. Date: Jun. 5, 2014

(54) SPINDLE MOTOR

(71) Applicant: SAMSUNG ELECTRO-MECHANICS CO., LTD., Suwon (KR)

(72) Inventors: Young Sam SHIM, Suwon (KR); Hyun Gi Yang, Suwon (KR)

(73) Assignee: SAMSUNG ELECTRO-MECHANICS CO., LTD., Suwon (KR)

(21) Appl. No.: 13/757,091

(22) Filed: Feb. 1, 2013

(30) Foreign Application Priority Data
Nov. 30, 2012 (KR) 10-2012-0137934

(51) Int. Cl. H02K 5/167

(52) U.S. Cl. CPC H02K 5/167
USPC 310/90

(57) ABSTRACT

There is provided a spindle motor, including: a sleeve fixed to a base member; a shaft rotatably inserted into the sleeve; and a rotor hub fixed to a top end portion of the shaft to be rotated together therewith and provided with an extension wall to form a liquid-vapor interface together with an outer circumferential surface of the sleeve, wherein the extension wall is provided with a protrusion portion protruded in an inner radial direction so as to reduce leakage of a lubricating fluid.

### CROSS-REFERENCE TO RELATED APPLICATIONS

This application claims the priority of Korean Patent Application No. 10-2012-0137934 filed on Nov. 30, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

Generally, a small spindle motor used in a hard disk drive (HDD) is provided with a hydrodynamic bearing assembly, a bearing clearance between a shaft and a sleeve of the hydrodynamic bearing assembly being filled with a lubricating fluid such as oil. Fluid dynamic pressure is generated in the oil filling the bearing clearance to rotatably support the shaft when the lubricating fluid is compressed.

Further, a bearing clearance may be formed between a top surface of the sleeve and a bottom surface of a rotor case coupled to a shaft of the motor and rotated together therewith. The bearing clearance formed between the top surface of the sleeve and the bottom surface of the rotor case is also filled with a lubricating fluid.

In the case of an external impact, the lubricating fluid may be leaked outwardly of the bearing clearance from a fluid-air interface formed between the lubricating fluid and air therein.

In the case that the lubricating fluid is leaked to the outside as described above, an amount of hydrodynamic pressure generated in the lubricating fluid may be reduced due to the reduced amount of lubricating fluid remaining in the bearing clearance. Consequently, the performance of the spindle motor may be degraded and the useful lifespan thereof may be shortened.

### RELATED ART DOCUMENT

(Patent Document 1) Japanese Patent Laid-Open Publication No. 2007-182946

### SUMMARY OF THE INVENTION

An aspect of the present invention provides a spindle motor capable of reducing leakage of a lubricating fluid.

According to an aspect of the present invention, there is provided a spindle motor, including: a sleeve fixed to a base member; a shaft rotatably inserted into the sleeve; and a rotor hub fixed to a top end portion of the shaft to be rotated together therewith and provided with an extension wall to form a liquid-vapor interface together with an outer circumferential surface of the sleeve, wherein the extension wall is provided with a protrusion portion protruded in an inner radial direction so as to reduce leakage of a lubricating fluid.

An upper portion of the outer circumferential surface of the sleeve may be inclined to form the liquid-vapor interface together with the extension wall.

The liquid-vapor interface may be disposed in a space formed between an inner surface of the protrusion portion and the outer circumferential surface of the sleeve when the rotor hub is stopped, a position at which the liquid-vapor interface contacts the rotor hub may be disposed above the protrusion portion in the axial direction when the rotor hub is initially rotated, and the position at which the liquid-vapor interface contacts the rotor hub may be moved to contact a top surface of the protrusion portion when the rotor hub is rotated.

The protrusion portion may be disposed at an end of the extension wall.

A diameter of an inner circumferential surface of the protrusion portion may be formed larger than that of a top surface of the sleeve.

The base member may be provided with a mounting portion for mounting the sleeve and the mounting portion may be provided with a protruding wall to form a labyrinth seal together with the extension wall.

At least one of a top surface of the sleeve and a bottom surface of the rotor hub disposed to face the top surface of the sleeve may be provided with a thrust dynamic pressure groove.

According to an aspect of the present invention, there is provided a spindle motor, including: a base member provided with a mounting portion protruded upwardly in an axial direction; a sleeve inserted into the mounting portion; a shaft rotatably inserted into the sleeve; a rotor hub fixed to a top end portion of the shaft to be rotated together therewith and provided with an extension wall to form a liquid-vapor interface together with an outer circumferential surface of the sleeve; and a cover member provided at a bottom end portion of the sleeve to prevent leakage of a lubricating fluid, wherein an end of the extension wall is provided with a protrusion portion protruded in an inner radial direction so as to reduce the leakage of the lubricating fluid.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is an enlarged view of portion A of FIG. 1;

FIG. 3 is a partially cutaway perspective view illustrating a sleeve and a rotor hub disposed in the spindle motor according to the embodiment of the present invention; and

FIGS. 4 through 6 are views illustrating an operation of a spindle motor according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

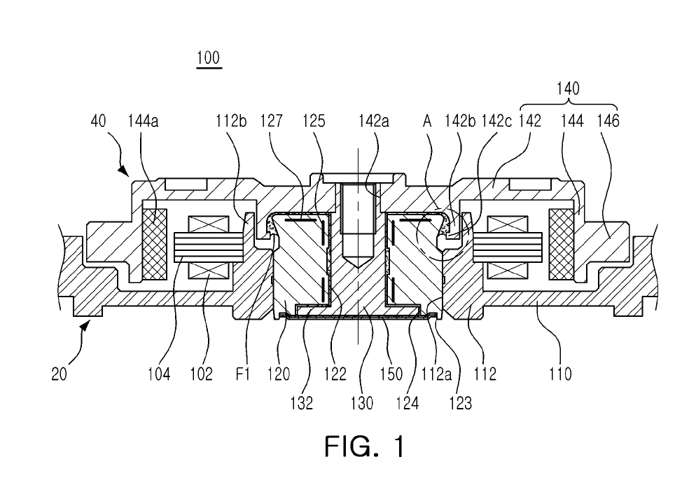

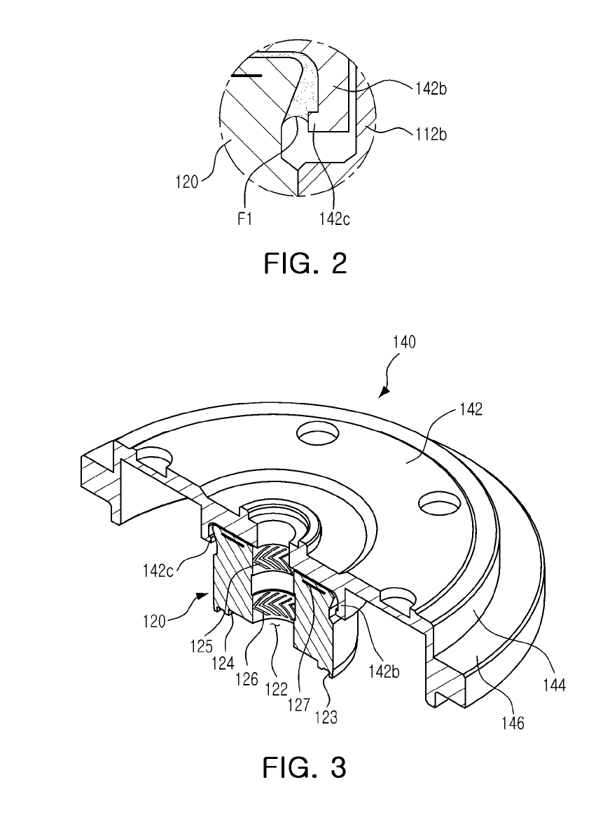

FIG. 1 is a schematic cross-sectional view illustrating a spindle motor according to an embodiment of the present invention, FIG. 2 is an enlarged view illustrating portion A of FIG. 1, and FIG. 3 is a partially cutaway perspective view illustrating a sleeve and a rotor hub disposed in the spindle motor according to the embodiment of the present invention.

Referring to FIGS. 1 through 3, a spindle motor 100 according to the embodiment of the present invention may include, for example, a base member 110, a sleeve 120, a shaft 130, a rotor hub 140, and a cover member 150.

Here, the spindle motor 100 may be a motor adopted in a hard disk drive driving a recoding disk.

Here, terms for directions will first be defined. As illustrated in FIG. 1, an axial direction refers to a vertical direction, that is, a direction from a lower portion of the shaft 130 toward an upper portion thereof or a direction from the upper portion of the shaft 130 toward the lower portion thereof, and a radial direction refers to a horizontal direction, that is, a direction from an outer circumferential surface of the rotor hub 140 toward the shaft 130 or from the shaft 130 toward the outer circumferential surface of the rotor hub 140.

In addition, a circumferential direction refers to a direction of rotation along the outer circumferential surface of the rotor hub 140 or the shaft 130.

The base member 110, a fixed member, configures a stator 20. Here, the stator 20 refers to all fixed members, except for rotating members, and may include the base member 110, the sleeve 120, and the like.

In addition, the base member 110 may include amounting portion 112 into which the sleeve 120 is inserted. The mounting portion 112 may be protruded upwardly in the axial direction and may be provided with a mounting hole 112a allowing the sleeve 120 to be inserted thereinto.

Meanwhile, the mounting portion 112 may be provided with a protruding wall 112b to form a labyrinth seal together with the rotor hub 140. In addition, a stator core 104 may be installed on an outer circumferential surface of the protruding wall 112b, the stator core 104 having a coil 102 wound therearound. The stator core 104 may be fixed to the outer circumferential surface of the protruding wall 112b by an adhesive or in a press-fitted manner.

Further, the base member 110 may be formed of aluminum (Al) by die-casting. In addition, a steel plate may be subjected to plastic working (for example, pressing) so as to be molded as the base member 110.

That is, the base member 110 may be formed of various materials and may be manufactured by various methods. The base member 110 is not limited to the embodiment illustrated in the drawings.

The sleeve 120 is a fixed member configuring the stator 20 together with the base member 120, and may be fixed to the base member 100.

That is, the sleeve 120 may be inserted into the mounting portion 112 and fixed thereto. In other words, a lower portion of the outer circumferential surface of the sleeve 120 may be bonded to an inner circumferential surface of the mounting portion 112 by at least one of an adhesive, welding, and press-fitting method.

Meanwhile, the sleeve 120 may be provided with a shaft hole 122 into which the shaft 130 is inserted. The shaft 130 may be inserted into the shaft hole 122 so as to be rotatably supported by the sleeve 120.

Further, a bottom end portion of the sleeve 120 may be provided with a mounting groove 123 in which the cover member 150 is installed for preventing a lubricating fluid from being leaked. Further, a bearing clearance filled with the lubricating fluid may be formed between a top surface of the cover member 150 and a bottom surface of the shaft 130, at the time of mounting the cover member 150.

Here, the bearing clearance will be described below.

The bearing clearance refers to a clearance filled with a lubricating fluid. That is, a clearance formed between an inner circumferential surface of the sleeve 120 and an outer circumferential surface of the shaft 130, a clearance formed between the sleeve 120 and the rotor hub 140, a clearance formed between the cover member 150 and the shaft 130, and a clearance formed between the shaft 130 and a bottom surface of the sleeve 120 are all defined as a bearing clearance.

Further, the spindle motor 100 according to the embodiment of the present invention adopts a structure in which the overall bearing clearance is filled with the lubricating fluid. Here, this structure is called a full-fill structure.

Meanwhile, the bottom end portion of the sleeve 120 may be provided with a step groove 124, and the step groove 124 will be described below in detail.

In addition, the inner circumferential surface of the sleeve 120 may be provided with upper and lower radial dynamic pressure grooves 125 and 126 to form a fluid dynamic pressure at the time of the rotational driving of the shaft 130. Further, the upper and lower radial dynamic pressure grooves 125 and 126 may be disposed to have a predetermined distance therebetween and may have a herringbone or spiral shape.

However, the foregoing upper and lower radial dynamic pressure grooves 125 and 126 are not limited to the case in which the upper and lower radial dynamic pressure grooves 125 and 126 are provided in the inner circumferential surface of the sleeve 120, and may be provided in the outer circumferential surface of the shaft 130.

In addition, an upper portion of the outer circumferential surface of the sleeve 120 may be inclined to form a liquid-vapor interface F1 together with the rotor hub 140.

That is, the upper portion of the outer circumferential surface of the sleeve 120 may be inclined to form the liquid-vapor interface F1 of the air and the lubricating fluid due to a capillary phenomenon.

Meanwhile, a top surface of the sleeve 120 may be provided with a thrust dynamic pressure groove 127. In addition, the thrust dynamic pressure groove 127 may also be provided in a bottom surface of the rotor hub 140 disposed to face the top surface of the sleeve 120. That is, the thrust dynamic pressure groove 127 may be provided in at least one of the top surface of the sleeve 120 and the bottom surface of the rotor hub 140 disposed to face the top surface of the sleeve 120.

However, the present invention is not limited thereto, and the thrust dynamic pressure groove 127 may also be provided in at least one of the bottom surface of the shaft 127 and the top surface of the cover member 150 disposed to face the bottom surface of the shaft 127.

The thrust dynamic pressure groove 127 generates dynamic pressure, floating the rotor hub 140 to a predetermined height at the time of the rotation of the rotor hub 140, and the liquid-vapor interface F1 may move to the bearing clearance due to the floating of the rotor hub 140.

A detailed description thereof will be described below.

The shaft 130, a rotating member, configures a rotor 40. Here, the rotor 40 refers to a member rotatably supported by the stator 20.

Meanwhile, the shaft 130 is inserted into the sleeve 120 and rotated. That is, the shaft 130 may be rotatably supported by the sleeve 120. Further, the bottom end portion of the shaft 130 may be provided with a flange portion 132 inserted into the step groove 124.

The flange portion 132 may extend in the outer radial direction from the bottom end portion of the shaft 130 and may serve to prevent the shaft 130 from overfloating while preventing the shaft 130 from being separated upwardly of the sleeve 120.

That is, in the case that the shaft 130 is separated upwardly of the sleeve 120 due to an external impact, the flange portion 132 prevents the shaft 130 from being separated from the sleeve 120. Further, the shaft 130 floats to a predetermined height, at the time of the rotational driving of the shaft 130. In this case, the flange portion 132 serves to prevent the shaft 130 from being excessively floated.

Further, the top end portion of the shaft 130 may be coupled to the rotor hub 140. For this purpose, when the shaft 130 is installed on the sleeve 120, the top end portion of the shaft 130 may be protruded upwardly of the sleeve 120.

The rotor hub 140, a rotating member configuring the rotor 40 together with the shaft 130, is fixed to the top end portion of the shaft 130 and is rotated together therewith.

Meanwhile, the rotor hub 140 may include a rotor hub body 142 having an mounting hole 142a into which the top end portion of the shaft 130 is inserted, a magnet mounting portion 144 extending downwardly in the axial direction from an edge of the rotor hub body 142, a magnet mounting portion 144 extended downwardly from an edge of the body 142 in the axial direction, and a disk seating portion 146 extending from an end of the magnet mounting portion 144 in the outer radial direction.

Further, a driving magnet 144a is provided on an inner surface of the magnet mounting portion 144 and the driving magnet 144a is disposed to face a front end of the stator core 104 around which the coil 102 is wound.

Meanwhile, the driving magnet 144a may have an annular ring shape and may be a permanent magnet generating magnetic force having a predetermined strength by alternately magnetizing an N pole and an S pole thereof in the circumferential direction.

Here, briefly describing the rotational driving of the rotor hub 140, when power is supplied to the coil 102 wound around the stator core 104, driving force rotating the rotor hub 140 may be generated by electromagnetic interaction between the driving magnet 144a and the stator core 104 around which the coil 102 is wound.

Therefore, the rotor hub 140 is rotated. In addition, the shaft 130 fixed to the rotor hub 140 by the rotation of the rotor hub 140 may be rotated together with the rotor hub 150.

Meanwhile, the rotor hub body 142 may be provided with an extension wall 142b extending downwardly in the axial direction so as to form the interface F1 between the lubricating fluid and air, that is, form the liquid-vapor interface F1 together with the outer circumferential surface of the sleeve 120.

An inner surface of the extension wall 142b may be disposed to face the upper portion of the outer circumferential surface of the sleeve 120.

Further, an end of the extension wall 142b may be provided with a protrusion portion 142c protruded in the inner radial direction so as to reduce the leakage of the lubricating fluid. A section of the protrusion portion 142c may have a rectangular shape.

That is, a position at which the liquid-vapor interface F1 contacts the rotor hub 140 at the time of the rotation of the rotor hub 140 moves downwardly in the axial direction due to the actions of centrifugal force and surface tension. In other words, the position at which the liquid-vapor interface F1 contacts the rotor hub 140 moves downwardly in the axial direction through the actions of centrifugal force and surface tension further than a position at which the liquid-vapor interface F1 contacts the sleeve 120.

However, since the end of the extension wall 142b is provided with the protrusion portion 142c, the position at which the liquid-vapor interface FI contacts the rotor hub 140 moves downwardly in the axial direction no longer by the actions of centrifugal force and surface tension.

In addition, the energy of the lubricating fluid is dissipated due to a turbulence generated by the protrusion portion 142c when an external impact occurs, such that a flow rate of the fluid may be reduced. Therefore, the leakage of the lubricating fluid due to the external impact may be further reduced.

This will be described in more detail in the operation of the spindle motor.

As such, the end of the extension wall 142b is provided with the protrusion portion 142, such that the leakage of the lubricating fluid may be further reduced.

Further, a diameter of an inner circumferential surface of the protrusion portion 142c may be formed to be larger than that of the top surface of the sleeve 120. Therefore, when the rotor hub 140 is mounted thereon, the interference between the protrusion portion 142c and the sleeve 120 may be prevented.

Meanwhile, the extension wall 142b forms a labyrinth seal together with the protruding wall 112b of the mounting portion 112. Therefore, a reduction in the amount of the lubricating fluid due to the evaporation of the lubricating fluid may be suppressed and the scattering of the lubricating fluid leaked from the bearing clearance may be reduced.

The cover member 150 is fixed to the mounting groove 123 of the sleeve 120 to prevent the lubricating fluid from being leaked to the bottom end portion of the sleeve 120. Meanwhile, the cover member 150 may be fixed to the sleeve 120 by at least one of an adhesive and welding.

Further, the cover member 150 may have a disk shape and may have an edge bent to be fixed to the sleeve 120.

As described above, the leakage of the lubricating fluid due to the rotational driving of the rotor hub 140 may be further reduced by the protrusion portion 142c. When an external impact occurs, the leakage of the lubricating fluid may be further reduced by the protrusion portion 142c provided on the extension wall 142b.

The operation of a spindle motor according to an embodiment of the present invention will be described below in more detail with reference to the drawings.

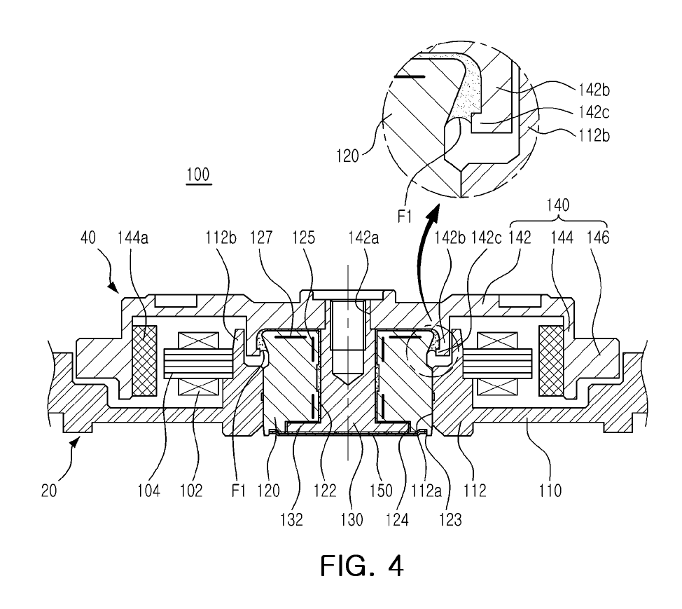

FIGS. 4 through 6 are views illustrating the operation of a spindle motor according to an embodiment of the present invention.

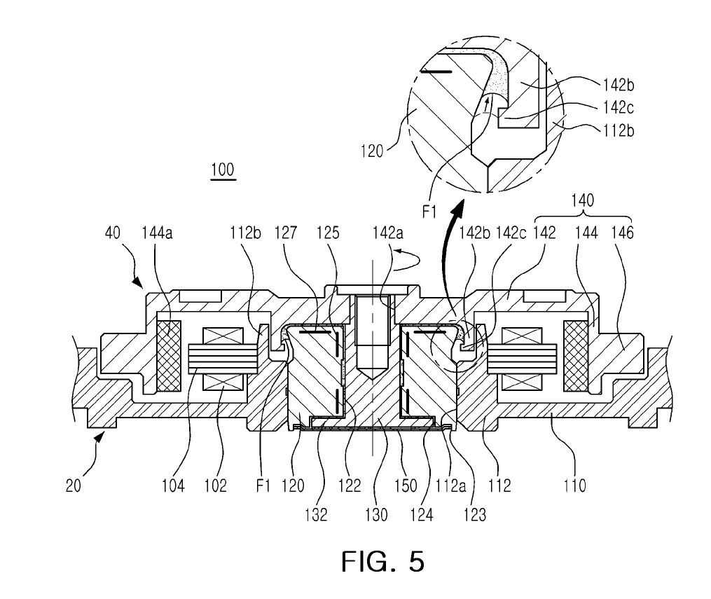

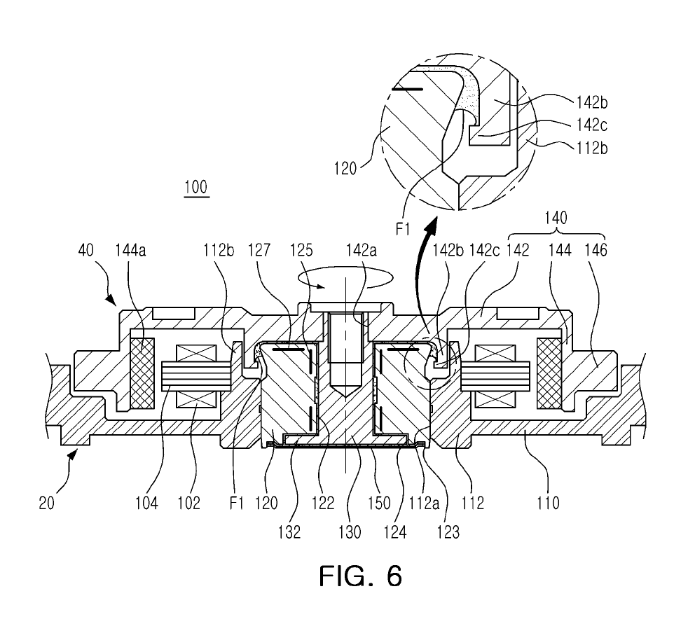

That is, FIG. 4 is a view illustrating a position at which the liquid-vapor interface is formed when the rotor hub is stopped, FIG. 5 is a view illustrating a position at which the liquid-vapor interface is formed at the time of the initial rotation of the rotor hub, and FIG. 6 is a view illustrating a position at which the liquid-vapor is formed at the time of the rotational driving of the rotor hub.

Referring to FIG. 4, the liquid-vapor interface F1 is initially disposed in a space formed between the inner surface of the protrusion portion 142c and the outer circumferential surface of the sleeve 120 when the rotor hub 140 is stopped. In this case, when an external impact occurs, the liquid-vapor interface F1 moves upwardly in the axial direction as illustrated in FIG. 5, and then the position at which the liquid-vapor interface F1 contacts the rotor hub 140 is moved to contact the top surface of the protrusion portion 142c as illustrated in FIG. 6.

In this case, a turbulence may occur in the lubricating fluid by the protrusion portion 142c. In other words, the lubricating fluid may not move further downwardly in the axial direction by the protrusion portion 142c, such that the lubricating fluid may move upwardly of the protrusion portion 142c.

Therefore, the energy of the lubricating fluid is dissipated due to the turbulence generated by the protrusion portion 142c, such that the flow rate of the fluid may be reduced. Consequently, the leakage of the lubricating fluid due to the external impact may be reduced.

Further, the liquid-vapor interface F1 moves upwardly in the axial direction due to the floating of the shaft 130 at the time of the initial rotational driving of the rotor hub 140 as illustrated in FIG. 5.

Next, when the rotor hub is continuously rotated, the liquid-vapor interface F1 moves as illustrated in FIG. 6. That is, the position at which the liquid-vapor interface F1 contacts the rotor hub 140 at the time of the rotation of the rotor hub 140 moves downwardly in the axial direction through the actions of centrifugal force and surface tension. In other words, the position at which the liquid-vapor interface F1 contacts the rotor hub 140 moves downwardly in the axial direction further than the position at which the liquid-vapor interface F1 contacts the sleeve 120, by the actions of centrifugal force and surface tension.

Even in this case, the extension wall 142b is provided with the protrusion portion 142c, such that the liquid-vapor interface F1 does not move therebeyond. Consequently, the leakage of the lubricating fluid due to the actions of centrifugal force and surface tension may be further reduced by the protrusion portion 142c, as compared with the case in which the protrusion portion 142c is not formed.

Further, even when an external impact occurs at the time of the rotational driving of the rotor hub 140, the energy of the lubricating fluid flowing as described above is dissipated due to the turbulence generated by the protrusion portion 142c, such that the flow rate of the fluid may be reduced. Consequently, the leakage of the lubricating fluid due to the external impact may be reduced.

As set forth above, according to embodiments of the present invention, the leakage of the lubricating fluid due to the rotational driving of the rotor hub can be further reduced by using the protrusion portion. When an external impact occurs, the leakage of the lubricating fluid can be reduced by the protrusion portion provided on the extension wall.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a sleeve fixed to a base member;
a shaft rotatably inserted into the sleeve; and
a rotor hub fixed to a top end portion of the shaft to be rotated together therewith and provided with an extension wall to form a liquid-vapor interface together with an outer circumferential surface of the sleeve,
wherein the extension wall is provided with a protrusion portion protruded in an inner radial direction so as to reduce leakage of a lubricating fluid.

2. The spindle motor of claim 1, wherein an upper portion of the outer circumferential surface of the sleeve is inclined to form the liquid-vapor interface together with the extension wall.

3. The spindle motor of claim 1, wherein the liquid-vapor interface is disposed in a space formed between an inner surface of the protrusion portion and the outer circumferential surface of the sleeve when the rotor hub is stopped,
a position at which the liquid-vapor interface contacts the rotor hub is disposed above the protrusion portion in the axial direction when the rotor hub is initially rotated, and
the position at which the liquid-vapor interface contacts the rotor hub is moved to contact a top surface of the protrusion portion when the rotor hub is rotated.

4. The spindle motor of claim 1, wherein the protrusion portion is disposed at an end of the extension wall.

5. The spindle motor of claim 1, wherein a diameter of an inner circumferential surface of the protrusion portion is formed to be larger than that of a top surface of the sleeve.

6. The spindle motor of claim 1, wherein the base member is provided with a mounting portion for mounting the sleeve, and
the mounting portion is provided with a protruding wall to form a labyrinth seal together with the extension wall.

7. The spindle motor of claim 1, wherein at least one of a top surface of the sleeve and a bottom surface of the rotor hub disposed to face the top surface of the sleeve is provided with a thrust dynamic pressure groove.

8. A spindle motor, comprising:
a base member provided with a mounting portion protruded upwardly in an axial direction;
a sleeve inserted into the mounting portion;
a shaft rotatably inserted into the sleeve;
a rotor hub fixed to a top end portion of the shaft to be rotated together therewith and provided with an extension wall to form a liquid-vapor interface together with an outer circumferential surface of the sleeve; and
a cover member provided at a bottom end portion of the sleeve to prevent leakage of a lubricating fluid,
wherein an end of the extension wall is provided with a protrusion portion protruded in an inner radial direction so as to reduce the leakage of the lubricating fluid.

9. The spindle motor of claim 8, wherein an upper portion of the outer circumferential surface of the sleeve is inclined to form the liquid-vapor interface together with the extension wall.

10. The spindle motor of claim 8, wherein the liquid-vapor interface is disposed in a space formed between an inner surface of the protrusion portion and the outer circumferential surface of the sleeve when the rotor hub is stopped,
a position at which the liquid-vapor interface contacts the rotor hub is disposed above the protrusion portion in the axial direction when the rotor hub is initially rotated, and
the position at which the liquid-vapor interface contacts the rotor hub is moved to contact a top surface of the protrusion portion when the rotor hub is rotated.
